(19) United States
(12) Patent Application Publication
(10) Pub. No.: US 2025/0324014 A1
(43) Pub. Date: Oct. 16, 2025

(54) RENDERING OF A MULTI-CHANNEL AUDIO SIGNAL

(71) Applicant: SAGEMCOM BROADBAND SAS, Bois-Colombes (FR)

(72) Inventors: Sébastien MALISSARD, Bois-Colombes (FR); Vincent SCHOTT, Bois-Colombes (FR); Frédéric SODI, Bois-Colombes (FR)

(21) Appl. No.: 19/175,470

(22) Filed: Apr. 10, 2025

(30) Foreign Application Priority Data
Apr. 15, 2024 (FR) 2403876

(51) Int. Cl. H04N 5/60; H04N 21/439; H04N 21/61

(52) U.S. Cl. CPC H04N 5/607; H04N 21/439; H04N 21/6118

(57) ABSTRACT

An accessory equipment includes a wireless communication circuit, and a routing circuit arrange to receive from a source equipment, via the input port and the first wired link, a digital audio-video signal including a video signal and audio channels, the audio channels including at least one first audio channel belonging to a multi-channel audio signal, and at least one second audio channel, transmit to the wireless communication circuit only the at least one first audio channel for the wireless communication circuit to transmit to at least one audio rendering equipment via a wireless link, and transmit to the audio-video rendering equipment only the video signal and the at least one second audio channel.

The invention relates to the field of home multimedia installations.

### BACKGROUND

A home multimedia system typically comprises a set-top box (or STB), a television set connected to the set-top box via an HDMI (High Definition Multimedia Interface) link, and eventually, additional audio rendering equipment, such as satellite speaker enclosures, a soundbar, a subwoofer, an audio headset, etc.

Some recent set-top boxes are also enhanced with advanced audio functions, with, for example, audio rendering capabilities via loudspeakers directly integrated into the set-top box. Thus, a set-top box integrating several “midrange” loudspeakers (also known as “medium” or “medial”) and a low-frequency loudspeaker (also known as “boomer” or “woofer”).

The use of several multiple audio rendering devices improves the quality of sound rendering and, more generally, the user experience, by enabling a multi-channel rendering that uses the relative positions of the different devices and their particular audio features.

By way of example, the audio system can be configured according to the “5.1.2” audio configuration mode This means that the audio system can render up to eight audio channels distributed as follows:
“5.x.x”: five horizontal audio channels, i.e. three channels in front of the user (left, right, centre) and two channels at the rear (left and right);
“x.1.x”: an audio channel dedicated to low frequencies;
“x.x.2”: two upfiring channels located to the left and to the right of the user (optional), simulating the arrival of channels from the ceiling of the room (for example, according to Dolby Atmos technology; DTS-X).

For example, it is possible to implement this configuration with the television set loudspeakers, a soundbar itself connected to a subwoofer, and satellite speaker enclosures. It is also possible, for example, to use a set-top box equipped with loudspeakers, and satellite speaker enclosures.

Modern satellite speaker enclosures are wireless speaker enclosures. The implementation of this multi-channel rendering therefore, requires the set-top-box to integrate a wireless communication module to transmit the audio channels to the speaker enclosures (and eventually, also to the soundbar in the case of a wireless soundbar). However, it is possible that the set-top box does not integrate a wireless communication module.

In this case, it is known to use an audio repeater which enables to extract the audio channels contained in an audio-video signal in HDMI format passing through an HDMI output port of the set-top box, and to transmit all of these audio channels to speaker enclosures (or other audio rendering devices) while transmitting all of the audio-video signal to the television set (and therefore, all of the audio channels). Thus, the television set and the speaker enclosures receive all the audio channels provided by the set-top box.

This situation is in FIG. 1, in the case of a multimedia system 1 comprising the set-top box 2, a television set 3, a soundbar 4, a Hi-Fi system 5, an audio headset 6 and therefore, the audio repeater 7. The audio repeater 7 is here connected to the television set 3 and to the set-top-box 2 via HDMI links, to the soundbar 4 by an S/PDIF link, to the Hi-Fi system 5 via an RCA/Cinch link, and to the audio headset 6 via a Bluetooth link.

In this case, the audio repeater 7 sends all the audio channels contained in the audio-video signal indifferently to the various audio rendering devices using different types of wired and/or wireless links (here HDMI RCA/Cinch, S/PDIF and Bluetooth).

The repeater 7 must therefore, operate only with homogeneous audio rendering devices (same link, same audio features) because the repeater does not enable the audio channels to be routed with different delays per channel.

In the event that heterogeneous devices are used, since the repeater 7 cannot optimise the sound rendering depending on the audio rendering devices, this forces the said devices to have their own audio processing chain. These devices are therefore, more complex and expensive.

### OBJECT

The object of the invention, in a multimedia system comprising a source equipment, an audio-video rendering equipment and audio rendering equipment, the source equipment not necessarily integrating a wireless communication module, is to improve the sound rendering of a multi-channel audio signal comprised in a digital audio-video signal that is broadcast via the source equipment, and this, without complicating the audio rendering equipment.

### SUMMARY

In order to achieve this aim, an accessory equipment is proposed comprising:
an input port arranged to be connected to a source equipment via a first wired link, and an output port arranged to be connected to an audio-video rendering equipment via a second wired link;
a wireless communication circuit;
a routing circuit arranged to:
   receiving from the source equipment, via the input port and the first wired link, a digital audio-video signal comprising a video signal and audio channels, the audio channels comprising at least one first audio channel belonging to a multi-channel audio signal, and at least one second audio channel;
   transmitting to the wireless communication circuit only the at least one first audio channel so that the wireless communication circuit transmits it to at least one audio rendering equipment via a wireless link;
   transmitting to the audio-video rendering equipment only the video signal and the at least one second audio channel.

The accessory equipment, which is therefore, connected to the source equipment via the first wired link, receives the audio channels and transmits them to the rendering equipment via the second wired link and via the wireless link. The source equipment therefore, does not need to integrate a wireless communication module to implement the multi-channel audio rendering.

The routing circuit directs each audio channel only to the equipment that is intended to render it according to the adopted multi-channel configuration. Consequently, by synchronising the audio channels in the source equipment and therefore, upstream of the accessory equipment (and prior to their transmission to the accessory equipment), a synchronised multi-channel rendering is ensured without the accessory equipment or the audio rendering equipment needing to carry out this synchronisation processing. An excellent quality of sound rendering is thus ensured without complicating the audio rendering equipment, and with very simple and very inexpensive accessory equipment.

In addition, an accessory equipment as described above is proposed, in which the routing circuit comprises a routing component comprising:
a main input connected to the input port of the accessory equipment, through which the video signal and the audio channels enter the routing component, and a main output connected to the output port of the accessory equipment;
at least one first output connected to the wireless communication circuit, and a second output and an input, the second output being looped back to the input,
an internal routing being implemented in the routing component, such that the video signal travels through the routing component from the main input to the main output, the at least one first audio channel travels through the routing component from the main input to the at least one first output, and the at least one second audio channel travels through the routing component from the main input to the second output, and then travels from the input to the main output.

In addition, an accessory equipment as described above is proposed, in which the second output is looped back on the input outside the routing component.

In addition, an accessory equipment as described above is proposed, in which the at least one first output, the second output and the input are of the I2S type.

In addition, an accessory equipment as described above is proposed, in which the wireless communication circuit is arranged to receive, of the at least one audio rendering equipment, via the wireless link, information indicating to it the first audio channel or channels to be transmitted to it.

In addition, an accessory equipment as described above is proposed, in which the first wired link and the second wired link are HDMI links, and in which the wireless communication circuit integrates a Wi-Fi or Bluetooth module.

In addition, an accessory equipment as described above is proposed, comprising a processing unit configured to apply at least one first specific delay to at least one of said at least one first audio channel and at least one second specific delay to at least one of said at least one second audio channel of the multi-channel audio signal, the first specific delay(s) and the second specific delay(s) being defined depending on the audio rendering capabilities of the at least one audio rendering equipment, of the audio-video rendering equipment or of an internal audio rendering device integrated into the source equipment for its rendering by said audio rendering device, and/or depending on features of the second wired link and the wireless link.

In addition, an accessory equipment as described above is proposed, in which the processing unit is further arranged to implement at least one first specific processing operation for each first audio channel and at least one second specific processing operation for each second audio channel, the first specific processing operation(s) and the second specific processing operation(s) being defined depending on the audio rendering capabilities of the at least one audio rendering equipment, of the audio-video rendering equipment or the internal audio rendering device of the source equipment, and/or depending on an audio configuration of the at least one audio rendering equipment.

In addition, a source equipment is proposed, comprising:
an output port arranged to be connected to an accessory equipment via a first wired link;
a processing unit arranged to:
   acquiring a digital audio-video signal comprising a video signal and a multi-channel audio signal;
   applying at least one first specific delay to at least one first audio channel and at least one second specific delay to at least one second audio channel of the multi-channel audio signal;
   transmitting the video signal and the at least one first audio channel to the accessory equipment via the output port and the first wired link, so that the accessory equipment retransmits the video signal to the audio-video rendering equipment via a second wired link and the at least one first audio channel to at least one audio rendering equipment via a wireless link;
   transmitting the at least one second audio channel to the accessory equipment via the output port and the first wired link for its rendering by the audio-video rendering equipment, or else to an internal audio rendering device integrated into the source equipment for its rendering by said audio rendering device;
the first specific delay(s) and the second specific delay(s) being defined depending on audio rendering capabilities of the at least one audio rendering equipment, of the audio-video rendering equipment, or the internal audio rendering device, and/or depending on features of the second wired link and the wireless link.

In addition, a source equipment as described above is proposed, the processing unit being further arranged to implement at least a first specific processing operation for each first audio channel and at least a second specific processing operation for each second audio channel,
the first specific processing operation(s) and the second specific processing operation(s) being defined depending on the audio rendering capabilities of the at least one audio rendering equipment, of the audio-video rendering equipment or the internal audio rendering device of the source equipment, and/or depending on an audio configuration of the at least one audio rendering equipment.

In addition, a source equipment as described above is proposed, in which the source equipment does not integrate an audio rendering device, and in which the processing unit is also arranged to transmit the at least one second audio channel to the accessory equipment via the output port and the first wired link for its rendering by the audio-video rendering equipment.

In addition, a source equipment as described above is proposed, in which the source equipment integrates an internal audio rendering device, the processing unit being arranged to transmit the at least one second audio channel to the internal audio rendering device for its rendering by said internal audio rendering device, the processing unit being further arranged to transmit to the accessory equipment, via the output port and the first wired link, at least one second virtual audio channel comprising only zero values.

In addition, an audio equipment as described above is proposed, the audio equipment being a set-top box.

In addition, a system is proposed, comprising an accessory equipment as described above, and a source equipment as described above.

In addition, an audio rendering method is proposed, implemented in the processing unit of a source equipment as described above, and comprising the steps of:
acquiring a digital audio-video signal comprising a video signal and a multi-channel audio signal;
applying at least one first specific delay to at least one first audio channel and at least one second specific delay to at least one second audio channel of the multi-channel audio signal;
transmitting the video signal and the at least one first audio channel to the accessory equipment via the output port and the first wired link, so that the accessory equipment retransmits the video signal to the audio-video rendering equipment via a second wired link and the at least one first audio channel to at least one audio rendering equipment via a wireless link;
transmitting the at least one second audio channel to the accessory equipment via the output port and the first wired link for its rendering by the audio-video rendering equipment, or else to an internal audio rendering device integrated into the source equipment for its rendering by said audio rendering device;
the first specific delay(s) and the second specific delay(s) being defined depending on audio rendering capabilities of the at least one audio rendering equipment, of the audio-video rendering equipment, or the internal audio rendering device, and/or depending on features of the second wired link and the wireless link.

In addition, a computer program is proposed, comprising instructions which lead the processing unit of the master equipment, such as described above, to execute the steps of the audio rendering method such as described above.

In addition, a computer-readable storage medium is proposed, on which the computer program, as described above, is recorded.

The invention will be better understood in the light of the description below of particular, non-limiting embodiments of the invention.

### BRIEF DESCRIPTION OF THE DRAWINGS

Reference will be made to the accompanying drawings, among which:

FIG. 1 shows a multimedia system of the prior art;

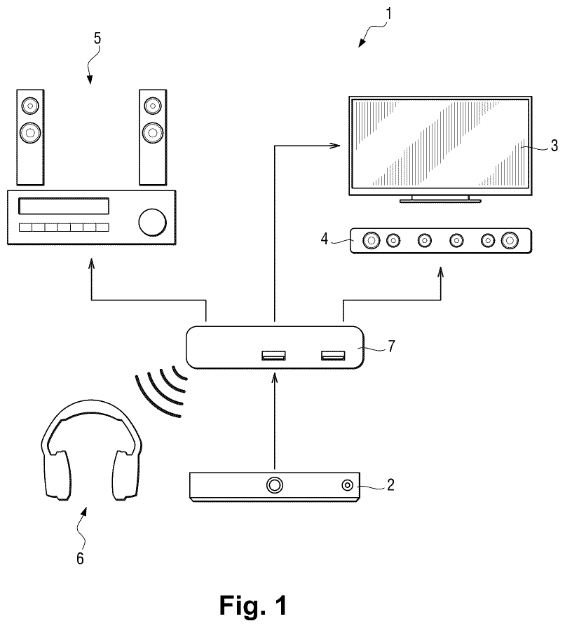

FIG. 2 shows a multimedia system according to a first embodiment;

FIG. 3 shows the set-top-box according to a first embodiment;

FIG. 4 represents the accessory equipment;

FIG. 5 shows the operation of the audio system;

FIG. 6 shows steps of the audio rendering method implemented in the set-top box;

FIG. 7 represents a multimedia system according to a second embodiment.

FIG. 8 represents the set-top-box according to a second embodiment.

### DETAILED DESCRIPTION

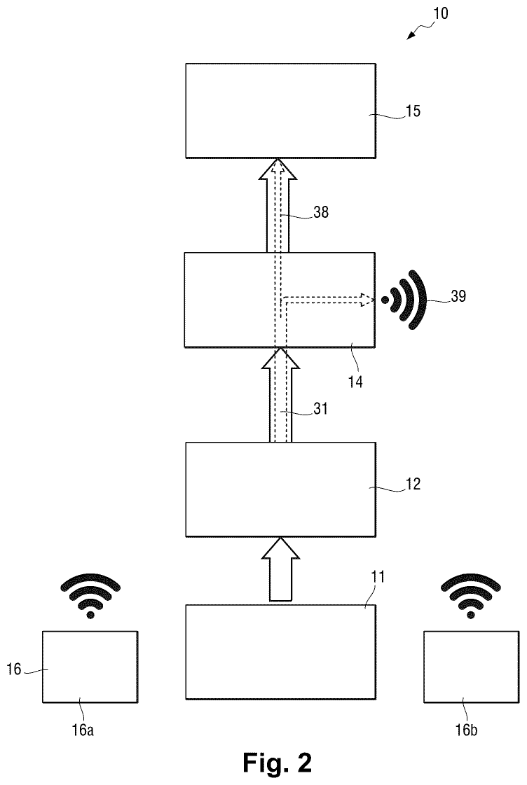

With reference to FIG. 2, the home multimedia system 10 according to a first embodiment comprises here a plurality of equipment comprising a home gateway 11, a set-top-box 12 according to a first embodiment, an accessory equipment 14, a television set 15 and two satellite speaker enclosures 16.

The set-top-box 12 does not comprise an audio rendering device and therefore, does not integrate a loudspeaker.

Here, each satellite speaker enclosure 16 is a dual-channel speaker enclosure comprising two loudspeakers. The speaker enclosures 16 are wirelessly connected speaker enclosures (here Wi-Fi). The speaker enclosure 16a is positioned behind the user to the left thereof, and the speaker enclosure 16b is positioned behind the user to the right thereof.

The audio rendering devices that render the audio signals are therefore, integrated here in the television set 15 and in the speaker enclosures 16. By “audio rendering device” this means at least one loudspeaker and electronic components connected to the loudspeaker, which format a digital audio signal so that it can be played by the loudspeaker (the electronic components comprise particularly, an audio amplifier).

These are “heterogeneous” devices, i.e. they have different audio rendering capabilities (their frequency response can, for example, be different).

The audio system, i.e. all the audio rendering devices of the multimedia system, is configured in the audio configuration mode “5.1.2”, and can therefore, render up to eight audio channels.

First, the set-top box 12 is described structurally, followed by the accessory equipment 14.

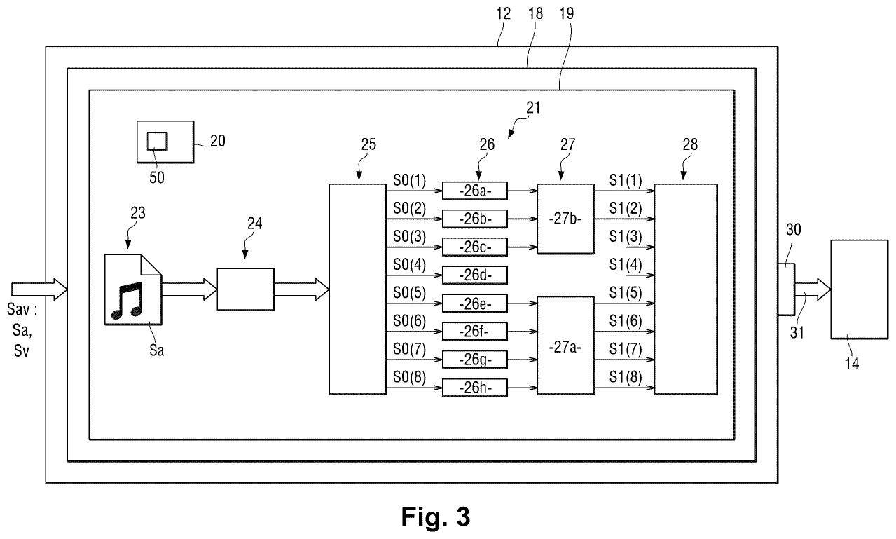

In reference to FIG. 3, the set-top box 12 comprises a processing unit 18.

The processing unit 18 is an electronic and software unit. The processing unit 18 comprises at least one processing component 19, which is for example, a “general purpose” processor, a processor specializing in signal processing (or DSP, for Digital Signal Processor), a processor specializing in artificial intelligence algorithms (NPU-type, for Neural Processing Unit), a microcontroller, or else a programmable logic circuit such as an FPGA (for Field Programmable Gate Arrays) or an ASIC (for Application Specific Integrated Circuit).

The processing unit 18 also comprises one or more memories 20, connected to or integrated in the processing component(s) 19. At least one of these memories 20 forms a computer-readable storage medium, on which is recorded at least one computer program, comprising instructions that lead the processing unit 18 to execute at least some of the steps of the audio rendering method that will be described.

The processing unit 18 integrates an audio processing chain 21, implemented in the processing component(s) 19, and comprising a number of processing modules. These processing modules comprise:
A receiving module 23;
An audio decoding module 24;
A mixing module 25;
A time delay module 26;
A post-processing module 27;
An output module 28.

The processing unit 18 acquires a Sav digital audio-video signal. The Sav digital audio-video signal is, for example, an external incoming stream from an external source: local network, satellite, cable, DVB-T (for Digital Video Broadcasting-Terrestrial), xDSL (which can be interpreted as “digital access line”), etc. The Sav audio-video signal is, for example, transmitted to the set-top box 12 via the gateway 11. The Sav audio-video signal can also be an internal incoming stream coming from an internal source to the set-top-box 12, for example, from a hard disk type HDD (Hard Disk Drive).

The Sav audio-video signal comprises a video signal Sv and a multi-channel audio signal Sa.

The Sav audio-video signal is encoded according to a given format (for example, Dolby Digital).

The receiving module 23 receives the signal Sa.

The audio decoding module 24 is configured to decode the multi-channel audio signal Sa so as to produce audio channels in a predetermined format, which in this example is the PCM (Pulse-Code Modulation) format.

The mixing module 25 is configured to mix channels: “up-mixing” to increase the number of channels or “down-mixing” to reduce the number of channels depending on the configuration of the audio system. The mixing module 25 produces up to eight audio channels S0(1) . . . S0(8).

The time delay module 26 comprises eight sub-modules 26a . . . 26h. Each sub-module is configured to apply a specific delay to each audio channel S0(1) . . . S0(8). The time delay module 26 therefore, produces a differentiated time delay per audio channel.

The application of these specific delays enables to obtain optimal synchronisation during the sound rendering by the loudspeakers of the television set 15 and the speaker enclosures 16, in order to maintain the same synchronisation as at the output of the audio set-top box 24.

The post-processing module 27 is configured to apply a specific audio processing for each type of audio rendering device. Here, the post-processing module 27 comprises a first sub-module 27a which implements a first audio processing specific to the wireless satellite speaker enclosures 16 and a second sub-module 27b which implements a second audio processing specific to the television set 15.

The output module 28 receives the audio channels S1(1) . . . S1(8) in PCM format as output from the audio processing chain 21.

The audio channels S1(1) . . . S1(8) are applied to the input of the output module 28 to be transmitted to the audio rendering devices.

The set-top box 12 further comprises an output port 30, which in this case, is an HDMI port.

The output port 30 is here connected to the accessory equipment 14 via a first wired link 31. This first wired link 31 is an HDMI link.

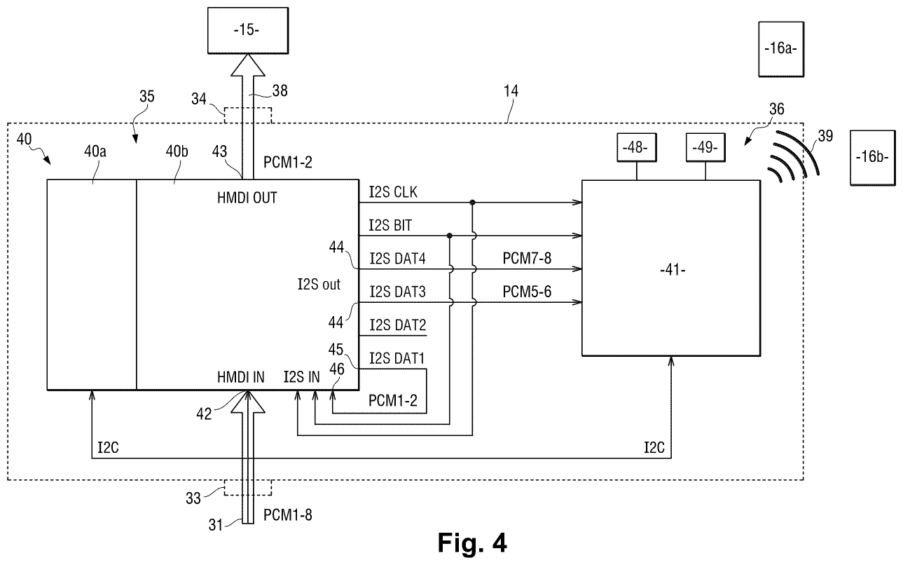

With reference to FIG. 4, the accessory equipment 14, which could be called “dongle”, comprises an input port 33, an output port 34, a routing circuit 35 and a wireless communication circuit 36.

The input port 33 of the accessory equipment 14 is therefore, connected to the output port 30 of the set-top-box 12 via the first wired link 31.

The output port 34 of the accessory equipment 14 is connected to the television set 15 via a second wired link 38, which is also an HDMI link.

The routing circuit 35 comprises a routing component 40, which in this example is an HDMI module. This is, for example, the Explore Tech EP91AXE component. The wireless communication circuit 36 implements a wireless link 39 (in this case in Wi-Fi) and comprises a wireless communication component 41, which in this case, is a Wi-Fi module and for example, the ESP32 component with the WiSA-DS firmware.

In general, the wireless communication component 41 can be adapted to communicate according to other wireless communication standards, such as Bluetooth, as long as the speaker enclosures 116 are compatible with these same other standards.

The routing component 40 comprises a control module 40a and a processing module 40b.

The processing module 40b of the routing component 40 comprises a main input 42, connected to the input port 33 of the accessory equipment 14, through which the video signal Sv and the audio channels S1(1) . . . S1(8) (therefore, PCM1-8) enter the routing component 40, and a main output 43 connected to the output port 34 of the accessory equipment 14.

The processing module 40b of the routing component 40 comprises at least a first output 44 connected to the wireless communication circuit 36, and a second output 45 and an input 46.

Here, the processing module 40b of the routing component 40 comprises two first outputs 44: these are the I2S DAT3 and I2S DAT4 outputs of the component 40.

The second output 45 is the I2S output DAT1.

The input 46 is an I2S in input.

The first outputs 44, the second output 45 and the input 46 are therefore, here in I2S (Integrated Interchip Sound) format.

The second output 45 is looped back to the input 46 outside of the routing component 40, in a hardware manner, i.e. by a conductive track or any other conductive element.

In the present embodiment, the loopback is carried out from the outside of the routing component 40. However, in other embodiments (not shown), the second output 45 can be looped back to the input 46 inside the routing component 40.

It is noted that the processing module 40b of the routing component 40 also comprises another output in the I2S format that is not used: I2S DAT2. The routing component 40 also comprises an I2S CLK output and an I2S BIT output, which loop back to separate I2S in inputs, and which are further connected to the communication component 41.

The processing module 40b further comprises an input of I2C type.

The communication component 41 also comprises an input of the I2C type.

The input port 33 of the accessory equipment 14 is connected to these two I2C inputs (as well as to the main input 42) of the routing component 40.

The accessory equipment also comprises a pairing button 48 and an indicator light 49, for example a light-emitting diode 49 (LED). The communication component 41 comprises an input connected to the button 48 and an output connected to the indicator light 49.

The pairing button 48 enables the user to associate the accessory equipment 14 with the satellite speaker enclosures 16. The indicator light 49 enables to indicate the status of the wireless transmission between the accessory equipment 14 and the satellite speaker enclosures 16. The pairing button 48 and the indicator light 49 are optional.

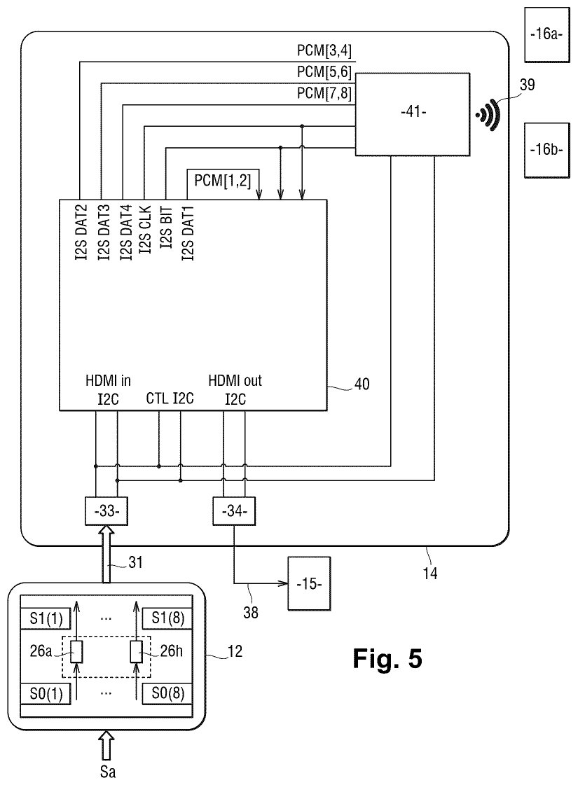

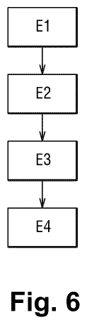

With reference also to FIGS. 5 and 6, an explanation is now given of the way in which the set-top-box 12 and the accessory equipment 14 cooperate to render a Sav digital video audio signal.

The digital video audio signal Sav is therefore, acquired by the processing unit 18 of the set-top box 12 (step E1). For example, the audio signal is in a 5.1.2 format signal.

The audio decoding module 24 and the mixing module 25 here produce seven audio channels only: S0(1), S0(2), S0(3), S0(5), S0(6), S0(7) and S0(8).

The channels S0(5), S0(6), S0(7) and S0(8) are first channels intended to be played by at least one, in this case, two audio rendering devices: the two speaker enclosures 16 (rear).

Each speaker enclosure 16 therefore, uses its two loudspeakers to render two audio channels. Here, for example, the speaker enclosure 16a renders the rear-left horizontal channel and the left elevation channel, while the speaker enclosure 16b renders the rear-right horizontal channel and the right elevation channel.

The channels S0(1), S0(2), S0(3) are second channels, intended to be played by audio-video rendering equipment, and therefore, here, by the loudspeaker of the television set 15.

These audio channels are in PCM format.

Each time delay module 26a . . . 26h applies a specific delay to the audio channel that it receives: the delay modules 26e . . . 26h apply first delays specific to the first audio channels S0(5) . . . S0(8), and the delay modules 26a . . . 26c apply second delays specific to the second audio channels S0(1) . . . S0(3): step E2.

The first specific delays and the second specific delays are defined depending on the audio rendering capacities of the at least one audio rendering equipment (in this case speaker enclosures 16), of the audio-video rendering equipment (in this case of the television set 15) or of the internal audio rendering device of the set-top box 12 (which does not comprise any in this embodiment), and/or depending on features of the second wired link 38 and of the wireless link 39.

The first specific delays and the second specific delays take into account the “heterogeneity” of the audio-video and audio: rendering equipment as to their audio rendering capabilities. The first specific delays and the second specific delays are therefore, defined depending on these audio rendering capacities, but also possibly depending on the features of the links connecting the accessory equipment 14 and the audio rendering equipment (HDMI-type wired link 38 on the one hand, and Wi-Fi wireless link 39 on the other hand).

The first specific delays and the second specific delays therefore, enable to synchronise the rendering of the first audio channels and the second audio channels despite the internal differences and the differences in means of communication between the television set 15 and the speaker enclosures 16.

There can be the same first specific delay for all the first audio channels, or else different first specific delays depending on the first audio channels. Similarly, there can be the same second specific delay for all the second audio channels, or else different second specific delays depending on the second audio channels.

The first audio channels S0(5), S0(6), S0(7) and S0(8) are then applied as input to the first post-processing sub-module 27a which implements first specific processing operations for the first audio channels. There can be a same first processing operation for all the first audio channels, or else different first processing operations depending on the first audio channels.

The second audio channels S0(1), S0(2), S0(3) as for them, are applied at the input of the second post-processing sub-module 27b which implements second specific processing operations for the second audio channels. There can be the same second processing operation for all the second audio channels, or else different second processing operations depending on the second audio channels.

The first specific processing operations and the second specific processing operations are defined depending on the audio rendering capacities of the at least one audio rendering equipment 16, of the audio-video rendering equipment 15 or of the internal audio rendering device of the set-top box 12 (which does not comprise any in this embodiment), and/or depending on an audio configuration of the at least one audio rendering equipment. By “audio configuration”, this means a spatial configuration of the audio rendering devices of the equipment concerned.

The first specific processing operations are specific to the satellite speaker enclosures 16, and these processing operations are therefore, carried out depending on the physical features of the loudspeakers of said speaker enclosures 16 (for example depending on their frequency response). In this case, these processing operations consist in equalising channels according to the type of speaker enclosure and the features of the integrated loudspeakers, for example by applying filters to extract the “medium” or the “treble”.

Optionally, these processing operations can include a frequency separation of a channel into several channels in distinct frequency domains, in the event that the satellite speaker enclosures 16 contain several loudspeakers for the same audio channel.

The second specific processing operations are specific to the television set 15, to render the audio channel from the central channel to the two front left and right channels. The post-processing 27b therefore, comprises here a “down-mixing”, intended for the internal loudspeakers of the television set 15, consisting in mixing three received channels (here front-left, front-right and centre channels) so as to obtain two channels (S1(1, S1(2)) which are interpreted by the television set 15 as a stereo audio signal (left channel and right channel). In particular, the second processing operations distribute the audio channel from the central channel to the two front left and right channels.

The different channels initially contained in the incoming Sa multi-channel audio signal have therefore, been extracted and processed, taking into account of the nature of the audio rendering devices, before being sent specifically to a rendering destination. In other words, each audio channel received a specific processing operation and delay according to the destination loudspeakers. From this differentiated routing results the application of a specific delay to each audio rendering device so as to obtain optimal synchronisation of the audio channels to ensure good sound rendering.

It is noted that the first processing operations and the second processing operations can include attenuation of the channels so as to obtain a homogeneous sound level with the other loudspeakers of the system.

The post-processing module 27 of the set-top box 12 therefore, supplies to the output module 28 an audio signal whose components S1(1) to S1(8) can be sent to several physical outputs (here HDMI, Wi-Fi). Here, as has been seen, the components S1(1) and S1(2) corresponding respectively to the PCM channels 1 and 2 are directed to the accessory equipment 14 in the direction of the television set 15, while the components S1(5), S1(6), S1(7), S1(8), corresponding respectively to the PCM channels 5 to 8, are directed to the accessory equipment 14 which performs a wireless transmission in the direction of the satellite speaker enclosures 16.

The accessory equipment 14, connected between the television set 15 and the set-top box 12, acts as an audio extraction/broadcasting module.

The accessory equipment 14 is configured to intercept all audio/video data streams passing through between the set-top box 12 and the television set 15 (HDMI streams) then to route and transmit the first audio channels S1(5) to S1(8) to the satellite speaker enclosures 16 and the second audio channels S1(1) and S1(2) to the television set 15, the first audio channels and the second audio channels comprising different channels adapted respectively to given audio rendering devices. For the video, the entire Sv video signal is retransmitted to the television set 15 (via an HDMI stream).

Thus, the processing unit 18 of the set-top box 12 transmits the Sv video signal and the at least one first audio channel to the accessory equipment 14 via the output port 30 and the first wired link 31, so that the accessory equipment 14 retransmits the video signal to the audio-video rendering equipment 15 via the second wired link 38 and the at least one first audio channel to at least one audio rendering equipment 16 via the wireless link 39: step E3.

The processing unit 18 transmits the at least one second audio channel to the accessory equipment 14 via the output port 30 and the first wired link 31 for its rendering by the audio-video rendering equipment: step E4. The routing circuit 35 therefore, transmits to the wireless communication circuit 36 only the first audio channels for the wireless communication circuit 36 to transmit to the speaker enclosures 16 via the wireless link 39. The routing circuit 35 transmits to the output port 34 only the video signal and the second audio channels, for their transmission to the television set 15.

An internal routing is implemented in the routing component 40 of the accessory equipment 14.

The internal routing is such that:
the Sv video signal travels through the routing component 40 from the main input 42 thereof to its main output 43;
the first audio channels S1(5) . . . S1(8) travel through the routing component 40 from the main input 42 to the first outputs 44;
the second audio channels S1(1), S1(2) travel through the routing component 40 from the main input 42 to the second output 45, and then travel through from the input 46 to the main output 43. The second output 45 is in fact, as has been seen, looped back to the input 46 from the outside of the routing component 40.

The transmission of the audio signals between the routing component 40 and the wireless communication component 41 is therefore, carried out via several I2S serial buses operating, for example, on 16 bits at 48 kHz, controlled by the routing component 40. Each I2S data bus is capable of transporting two audio channels. Thus, the four I2S buses (DAT1, DAT2, DAT3, DAT4) at the output of the routing component 40 can transmit all eight PCM audio channels received on its HDMI input port (HDMI in).

The wireless communication component 41 transmits the first PCM audio channels 5-6 (therefore, S1(5) and S1(6)) to the speaker enclosure 16a, and the first PCM audio channels 7-8 (thus, S1(7) and S1(8)) to the speaker enclosure 16b.

The wireless communication component 41 receives from the speaker enclosures 16, via the wireless link 39, information indicating to it the first audio channel(s) to be transmitted to it. Here, the speaker enclosures 16 therefore, communicate with the accessory equipment 14 to indicate to it the expected channels (depending on their position, for example, or else, their own audio features). The configuration of the speaker enclosures 16 is carried out, for example, for each speaker enclosure 16, by one or more resistors connected to one or more GPIO inputs of a processor component (microcontroller for example) of the speaker enclosure 16.

The routing component 40 transmits the Sv video signal directly to the television set 15. The routing component 40 operates in “passthrough” mode, i.e. it transmits the images without modifying them, within the limits of the formats and maximum flow rate supported by the television set 15 and the accessory equipment 14 (for example: flow rate limitation if HDMI 2.0 is not supported).

The accessory equipment 14 therefore, contributes to performing a “differentiated routing” of the audio channels, insofar as only the audio channels PCM 1, PCM 2 are sent to the television set 15, while the other PCM channels 5 to 8 are sent to the satellite speaker enclosures 16. In the example of FIG. 4, the I2S DAT2 output has not been used but could be, for example, to transmit two additional PCM channels to an additional speaker enclosure.

It can therefore, be seen that the distribution of audio channels is carried out in a hardware manner.

This distribution is carried out at the level of the speaker enclosures 16 (here, via the resistors connected to the GPIO inputs) enabling to indicate to the accessory equipment 14 the expected channels.

This distribution is also carried out in the accessory equipment 14. This distribution is materialized by a “hard” electrical wiring in the accessory equipment 14. Here, this wiring ensures that the eight PCM channels at the HDMI output of the set-top box 12 (the PCM channels 1 to 8 provided on the HDMI input port in) are distributed as follows:
PCM channels 1, 2: to HDMI stereo TV (PCM 2.0);
PCM Channels 3, 4: not used in the present example;
PCM Channels 5, 6, 7, 8: to Wi-Fi satellite speaker enclosures.

More precisely, the “internal routing” of the I2S data buses carried out in hard in the accessory equipment 14, is as follows:
DAT1 corresponds to PCM channels 1 and 2 of the input HDMI port (HDMI in). As has been seen, DAT 1 is looped back on itself, therefore, on the input port I2S in, so as to be transmitted to the television set 15 in the form of PCM 2.0. This loopback is a very clever feature from a material point of view;
DAT2 corresponds to PCM channels 3 and 4 of the input HDMI port (HDMI in), these two channels not being used in the present embodiment;
DAT3 corresponds to PCM channels 5 and 6 of the input HDMI port (HDMI in), these two channels being sent to the wireless communication circuit 36; and
DAT4 corresponds to the PCM channels 7 and 8 of the input HDMI port (HDMI in), these two channels being sent to the wireless communication circuit 36.

Thus, the accessory equipment 14 advantageously has the same and unique hardware configuration enabling to perform the following tasks, depending on the case in question (restitution of certain audio channels on the television set 15 and/or other channels on the speaker enclosures 16):
routing the video channel to the television set 15;
routing certain audio channels (the second audio channels) to the television set 15;
routing other audio channels (the first audio channels) to the satellite speaker enclosures 16;
Wi-Fi transmission/reception to communicate with satellite speaker enclosures 16.

The accessory equipment 14 does not need to know the assignment of the audio channels that it transports, it only performs audio routing, which enables it to transparently support the different configurations of the system (in particular, the rear speaker enclosures with elevation or with medium and treble loudspeakers).

Preferably, the accessory equipment 14 is aware of the audio and video formats or codecs supported by the television set 15. For example, it receives the EDID (Extended Display Identification Data) from the television set 15. The accessory equipment 14 acquires all or part of the video codecs of the television set 15 to which it is connected. As an HDMI repeater, the accessory equipment 14 selects according to the EDID the adapted video codecs depending on the television set 15. The accessory equipment 14 ignores, for the audio part, the audio codecs of the television set 15 and signals the single “PCM with 8 audio channels” type support via its own EDID. Thus, the set-top box 12 receives by repetition in the EDID information of the accessory 14, the video codecs supported by the television set 15 and, by replacement, the single audio codec of the “PCM with 8 audio channels” type.

Advantageously, the configuration of the audio system is dynamic insofar as the user can select an audio configuration among a set of configurations, which are for example, recorded in the set-top box 12. For this purpose, a configuration file is recorded, preferably in one of the memories 20 of the processing unit 18 of the set-top box 12. This file comprises a cross-reference table 50 between the input channels (i.e. comprised in the Sa multi-channel audio signal) and the output channels. This cross-reference table 50 corresponds to predefined configuration modes relative to the hardware deployed on the user's premises (for example, the set-top-box 12, the number and types of external speaker enclosures 16, the number of loudspeakers per speaker enclosure 16 and the frequency response of the loudspeakers, etc.). For example, the user can select the type of speaker enclosure by indicating the number of channels per speaker enclosure. Each configuration is associated with specific processing operations which are also indicated in the configuration file. Depending on the user's choice, the set-top-box 12 dynamically selects the audio output channels as well as the processing operation(s) to be applied on the basis of the information contained in the file.

It can be seen that the accessory equipment 14 is therefore, particularly advantageous for performing differentiated routing of the audio channels from a set-top box 12 already deployed and not having wireless communication means, regardless of the nature of the set-top box 12 (with or without an audio rendering device), given that the accessory equipment 14 can be easily added to an existing system (which would comprise, for example, a set-top box, a television set and satellite speaker enclosures).

The proposed solution enables a reduction of complexity insofar as the audio rendering devices do not require decoding. For example, the satellite speaker enclosures 16 of the audio system must not carry out any audio signal processing (particularly, decoding).

The invention is particularly advantageous, in the event that satellite speaker enclosures without digital processing capacity are added in addition to the loudspeakers of a television set and/or a digital audio source (set-top box with or without loudspeakers) to obtain an optimal sound rendering.

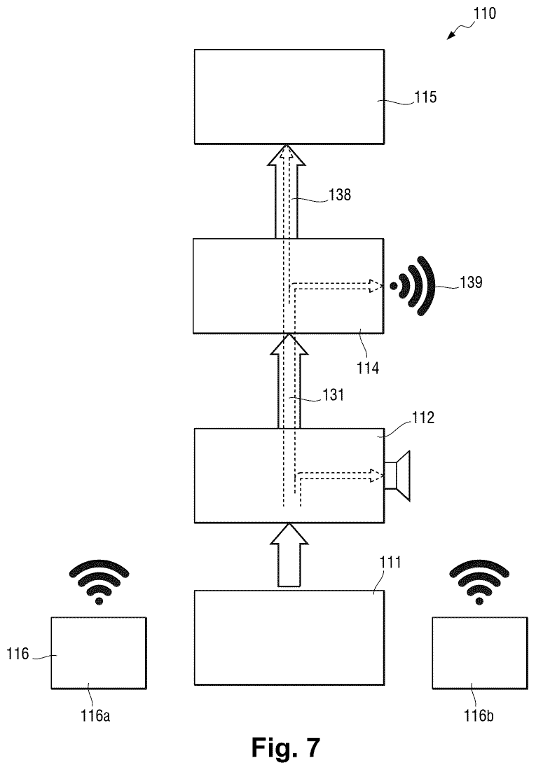

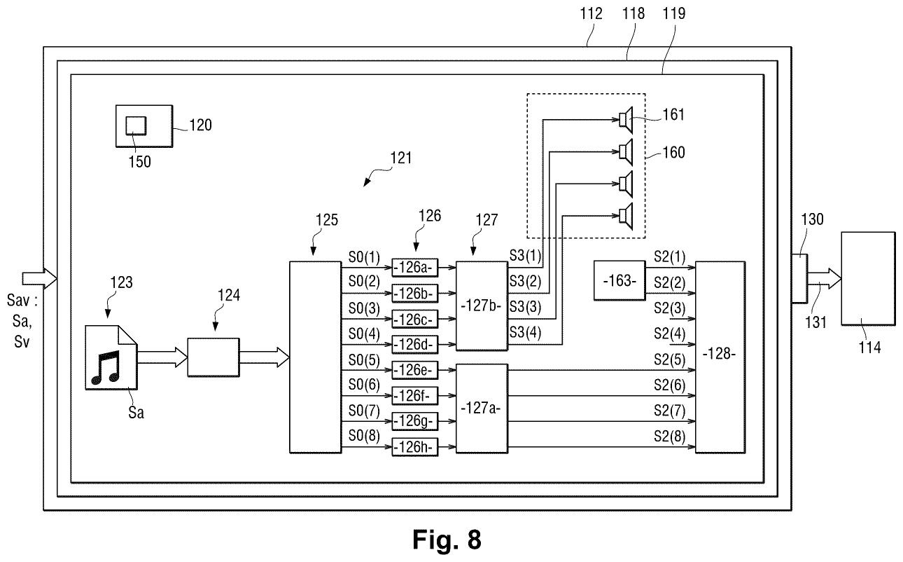

A set-top box 112 according to a second embodiment is now considered, with reference to FIGS. 7 and 8.

In FIGS. 7 and 8, «100» is added to all the references of similar elements already present in FIGS. 3 and 4.

This time, the set-top box 112 integrates an internal audio rendering device 160, comprising at least one loudspeaker 161, in this case, four loudspeakers 161. The set-top-box 112 is thus, capable of rendering four audio channels: a front-left channel, a central channel, a front-right channel and a bass channel.

The audio processing chain 121 of the processing unit 118 comprises:
A receiving module 123;
An audio decoding module 124;
A mixing module 125;
A time delay module 126;
A post-processing module 127;
A silence generation module 163;
An output module 128.

The silence generator 163 enables to generate a non-audible audio signal, all values of which are zero.

This time, the audio decoding module 124 and the mixer module 125 produce eight audio channels: S0(1), S0(2), S0(3), S0(4), S0(5), S0(6), S0(7) and S0(8).

The channels S0(5), S0(6), S0(7) and S0(8) are intended to be played by at least one, in this case, by two audio rendering devices: the two speaker enclosures 116.

The channels S0(1), S0(2), S0(3), S0(4) are intended to be played by the internal audio rendering device 160 of the set-top box 112.

The time delay modules 126e . . . 126h apply first specific delays to the first audio channels, and the time delay modules 126a . . . 126d apply second specific delays to the second audio channels.

The first specific delays and the second specific delays are defined depending on the audio rendering capabilities of the speaker enclosures 116 and of the internal audio rendering device 160 of the set-top box 112, and depending on features of the second wired link (connecting the accessory equipment and the television set) and of the wireless link (connecting the accessory equipment 114 to the speaker enclosures 116).

The first specific delays and the second specific delays therefore, take into account the “heterogeneity” of the audio-video and audio rendering equipment as to their audio rendering capabilities.

The audio channels S0(5), S0(6), S0(7) and S0(8) are then applied as input to the first post-processing sub-module 127a which implements a first specific processing operation for each first audio channel.

The audio channels S0(1), S0(2), S0(3), S0(4) are then applied as input of the second post-processing sub-module 127b, which implements a second specific processing operation for each second audio channel.

The first specific processing operations are specific to the wireless satellite speaker enclosures 116, these processing operations being carried out depending on the physical features of the loudspeakers of said speaker enclosures (for example depending on their frequency response). In this case, these processing operations consist in equalising channels according to the type of speaker enclosure and the features of the integrated loudspeakers, for example by applying filters to extract the “medium” or the “treble”.

Optionally, these processing operations can include frequency separation of a channel into several channels in distinct frequency domains, in the event that the satellite speaker enclosures contain several loudspeakers for the same audio channel.

The first post-processing sub-module 127a therefore, produces the first audio channels S2(5) . . . S2(8).

The second specific processing operations are specific to the internal audio rendering device 160 of the set-top box 112. These processing operations are carried out depending on the physical features of the loudspeakers 161 of the internal audio rendering device 160 of the set-top box unit 112 (for example their frequency response).

The second post-processing sub-module 127b therefore, produces the second audio channels S3(1) . . . S3(4).

The second audio channels are transmitted to the internal audio rendering device 160 integrated in the set-top box 112 for their rendering by said internal audio rendering device 160.

The second audio channels S3(1) . . . S3(4) are therefore, not transmitted to the accessory equipment 114 via the first wired link 131.

The processing unit 118 of the set-top box 112, however, transmits to the accessory equipment 114, via the output port 130 and the first wired link 131, at least one second virtual audio channel comprising only zero values. The second virtual audio channels S2(1) S2(2) are produced by the silence generation module 163 and then applied to the input of the output module 128 which transmits them to the accessory equipment 114.

The four logical channels S3(1) to S3(4) are the outputs after post-processing 127b of the four channels S0(1) to S0(4). Thus, at the end of the steps of pre-processing by the mixing module 125 and post-processing by the post-processing module 127b, the channels corresponding to the four audio channels S0(1) to S0(4) of the incident multi-channel audio stream are “routed” respectively to the four loudspeakers 161 of the set-top box 112.

The channels S2(5), S2(6), S2(7) and S2(8), at the outputs of the post-processing module 127a, provided at the output module 128, correspond to the channels S0(5), S0(6), S0(7) and S0(8) of the signal provided by the audio decoding module 124. On this audio output, a silence signal is sent on the S2(1) and S2(2) channels. Since the audio signals S2(3) and S2(4) are not used in the rest of the system, they are not explicitly connected to a source. This audio output is directed to the accessory equipment 114.

As for the accessory equipment 114, it therefore, receives the video signal, the first audio channels S2(5) to S2(8), and second audio channels S2(1), S2(2), which are virtual channels comprising only silence.

The routing circuit transmits to the wireless communication circuit only the at least one first audio channel so that the wireless communication circuit transmits it to the speaker enclosures via the wireless link 139. The routing circuit transmits to the television set 115 only the video signal and the at least one second audio channel.

Once again, the internal routing that is implemented in the routing component is therefore, such that the video signal travels through the routing component from the main input to the main output. The first audio channels travel through the routing component from the main input to the first outputs to be transmitted by the wireless communications component to the speaker enclosures. The second virtual audio channels travel through the routing component from the main input to the second output and then travel through from the input to the main output. The television set 115 therefore, renders a silence signal, the second real audio channels being rendered by the set-top box equipment 112.

Thus, for the accessory equipment, the change of mode of the second channels (silence instead of real audio channels) is totally transparent.

Naturally, the invention is not limited to the embodiments described, but comprises any variant entering into the scope of the invention such as defined by the claims.

The source equipment is not necessarily a set-top box (STB, enhanced or not with audio rendering means), this can be any other digital audiovisual source intended to transmit digital audio data from a multi-channel audio stream to a set of possibly heterogeneous audio rendering devices, this source can comprise sound rendering means. The source equipment could be, for example, a television set or a video projector.

The components of the accessory equipment can be different from those described here. The routing circuit and the wireless communication circuit can each comprise several components.

Wired links are not necessarily HDMI links. Another wired format, suitable for transmitting a multi-channel audio signal, can be envisaged, and for example, one of the USB-C, DisplayPort, Thunderbolt formats.

The invention has been described in the event that the audio system comprises a pair of wireless satellite speaker enclosures for a “5.1.2” audio configuration. Naturally, the invention applies equally well to other audio configurations that can involve other types of audio rendering devices, such as a soundbar, a subwoofer. In addition, it will be noted that the number of speaker enclosures or loudspeakers is not limiting, whether they are the television set loudspeakers, the set-top box, the satellite speaker enclosures, the subwoofer, etc.

The speaker enclosures need not necessarily be dual-channel speaker enclosures.

In general, a speaker enclosure comprises one or more loudspeakers, each of the loudspeakers being able to receive a different audio channel (for example, a speaker enclosure comprising four loudspeakers can render four different channels: front-left, front-right, centre, bass).

A single-channel speaker enclosure comprising a loudspeaker can be used to render a single audio channel of the system, for example, a horizontal rear-left or rear-right channel.

A physical loudspeaker with two loudspeakers (for example, an ATMOS speaker enclosure with a loudspeaker pointing to the ceiling, i.e. “up-firing”) can be configured (via sound amplifier programming) to use a single logical audio channel (for example, the rear-left horizontal channel or rear-right horizontal channel) and duplicate it on both loudspeakers (“duplicate” mode). In another operating mode, this speaker enclosure can receive two logical channels corresponding to the same source audio channel but which have potentially received a different processing operation, and each logical audio channel can be routed, for example, to a loudspeaker dedicated to the rendering of the mediums and another loudspeaker dedicated to the rendering treble rendering.

A physical speaker enclosure integrating two loudspeakers can also be configured to receive two logical channels and transmit them to each of the two loudspeakers.

The audio system has been described as comprising rear speaker enclosures. However, speaker enclosures at the front (or any other position) can be added in addition to or in replacement of other loudspeakers in the system.

The position of the speaker enclosures described here is static (hardware configuration), but another embodiment would enable the user to assign the position (rear-left or rear-right) of the speaker enclosures dynamically (for example, via a configuration menu from the set-top box).

In the audio channels shown in Figures, the signals S1, S2 and S3 do not necessarily respect the same order of the channels making up the signal S0 at the output of the audio decoding module.

For example, in the first embodiment, the channel 3 at the output of the audio decoding module 24, denoted S0(3), representing the central channel of the original audio signal, is mixed with channels S1(1) and S1(2) at the output of the set-top box. In the second embodiment, in the event that the loudspeakers are configured to render two audio channels, the system (via the set-top box) can be configured to extract by frequency separation from a same channel S0(X) two new signals that can be transmitted to the channels S2(5) and S2(7) at the output of the set-top box.

In the embodiments previously described, the time delay module 26, 126 and the post-processing module 27, 127 are included in the set-top-box 12, 112 or more generally in the source equipment. In other embodiments (not shown), all or part of the functionalities implemented by the time delay module 26, 126 and/or the post-processing module 27, 127 as described above with reference to FIGS. 3, 8 could be offset in the accessory equipment 14, 114, on the condition that the set-top-box 12, 112 does indeed maintain the same number of PCM channels on its output port 30, 130, this number being for example, equal to 8 for an audio configuration mode 5.1.2. The offset functionalities are implemented by means of a processing unit integrated in the accessory equipment.

According to a particular feature of the invention, the processing unit of the accessory equipment is configured to apply at least one first specific delay to at least one first audio channel and at least one second specific delay to at least one second audio channel. The first audio channel and the second audio channel are provided by the source equipment (e.g. the set-top box 12, 112). The first specific delay(s) and the second specific delay(s) are defined depending on audio rendering capabilities of at least one audio rendering equipment 16, 116, of the audio-video rendering equipment 15; 115 or of the internal audio rendering device 160, and/or depending on features of the second wired link 38, 138 and of the wireless link 39, 139.

In the event that t the source equipment comprises the internal audio rendering device 160, the accessory equipment 114 is further configured to retrieve from the audio-video rendering device 115 a first delay value relating to this device and communicate it to the source equipment. For example, this delay value is part of the EDID information of the television set 115.

In addition, the accessory equipment 114 can be configured to obtain a second delay value from the audio rendering equipment 116. The second delay value can also be a fixed value, of 40 ms, for example.

As soon as the first and second delay values are known to the processing unit of the accessory equipment, it can be configured to determine a maximum reference delay corresponding to the greater of the values selected from the first and second delay values (e.g. selection of the highest delay among the delay due to the television set and the delay due to the speaker enclosures).

Preferably, it is this maximum reference delay value that is transmitted by the accessory equipment 114 to the source equipment 112.

This enables the source equipment 112 to synchronise the audio rendering of the internal audio rendering device 160 with that carried out by the audio rendering equipment 116 and with that carried out by the audio-video rendering device 115.

For example, at an instant t=0, there is an audio-video signal at the output 130 at t=0s (no delay), while a delay is applied to the internal audio rendering device 160 (delay t=−40 ms).

The accessory equipment 114 transmits a new delay in its EDID, which is therefore, a combination of the first delay value and the second delay value mentioned earlier.

According to another particular feature of the invention, the processing unit of the accessory equipment is further configured to implement at least one first specific processing operation for each first audio channel and at least one second specific processing operation for each second audio channel. The first specific processing operation(s) and the second specific processing operation(s) are defined depending on the audio rendering capacities of at least one audio rendering equipment 16, 116, of the audio-video rendering equipment 15, 115 or of the internal audio rendering device 160 of the source equipment 112, and/or depending on an audio configuration of the at least one audio rendering equipment.

1. An accessory equipment, comprising:
an input port arranged to be connected to a set-top-box by a first wired link, and an output port arranged to be connected to audio-video rendering equipment by a second wired link;
a wireless communication circuit;
a routing circuit arranged to:
receive from the set-top box, via the input port and the first wired link, a digital audio-video signal comprising a video signal and audio channels, the audio channels comprising at least one first audio channel belonging to a multi-channel audio signal, and at least one second audio channel;
transmit to the wireless communication circuit only the at least one first audio channel for the wireless communication circuit to transmit to at least one audio rendering equipment via a wireless link;
transmit to the audio-video rendering equipment only the video signal and the at least one second audio channel.

2. The accessory equipment according to claim 1, wherein the routing circuit comprises a routing component comprising:
a main input connected to the input port of the accessory equipment, through which the video signal and the audio channels enter in the routing component, and a main output connected to the output port of the accessory equipment;
at least one first output connected to the wireless communication circuit, and a second output and an input, the second output being looped back to the input,
an internal routing being implemented in the routing component, such that the video signal travels through the routing component from the main input to the main output, the at least one first audio channel travels through the routing component from the main input to the at least one first output, and the at least one second audio channel travels through the routing component from the main input to the second output, then travels from the input to the main output.

3. The accessory equipment according to claim 2, wherein the second output is looped back to the input outside the routing component.

4. The accessory equipment according to claim 2, wherein the at least one first output, the second output and the input are of the I2S type.

5. The accessory equipment according to claim 1, wherein the wireless communication circuit is arranged to receive of the at least one audio rendering equipment, via the wireless link, information indicating the first audio channel or channels to be transmitted to it.

6. The accessory equipment according to claim 1, wherein the first wired link and the second wired link are HDMI links, and wherein the wireless communication circuit integrates a Wi-Fi or Bluetooth module.

7. The accessory equipment according to claim 1, comprising a processing unit configured to apply at least one first specific delay to at least one of said at least one first audio channel and at least one second specific delay to at least one of said at least one second audio channel of the multi-channel audio signal, the at least one first specific delay(s) and the at least one second specific delay(s) being defined depending on audio rendering capabilities of the at least one audio rendering equipment, of the audio-video rendering equipment or of an internal audio rendering device integrated in the set-top box for its rendering by said audio rendering device, and/or depending on features of the second wired link and of the wireless link.

8. The accessory equipment according to claim 1, wherein the processing unit is further arranged to implement at least one first specific processing operation for each first audio channel and at least one second specific processing operation for each second audio channel, the first specific processing operation(s) and the second specific processing operation(s) being defined depending on the audio rendering capabilities of the at least one audio rendering equipment, of the audio-video rendering equipment or of the internal audio rendering device of the set-top box, and/or depending on an audio configuration of the at least one audio rendering equipment.

9. A set-top box, comprising:
an output port arranged to be connected to an accessory equipment via a first wired link;
a processing unit arranged to:
acquire a digital audio-video signal comprising a video signal and a multi-channel audio signal;
apply at least one first specific delay to at least one first audio channel and at least one second specific delay to at least one second audio channel of the multi-channel audio signal;
transmit the video signal and the at least one first audio channel to the accessory equipment via the output port and the first wired link, so that the accessory equipment retransmits the video signal to the audio-video rendering equipment via a second wired link and the at least one first audio channel to at least one audio rendering equipment via a wireless link;
transmit the at least one second audio channel to the accessory equipment via the output port and the first wired link for its rendering by the audio-video rendering equipment, or else to an internal audio rendering device integrated in the set-top box for its rendering by said audio rendering device;
the first specific delay(s) and the second specific delay(s) being defined depending on audio rendering capabilities of the at least one audio rendering equipment, of the audio-video rendering equipment or the internal audio rendering device, and/or depending on features of the second wired link and the wireless link.

10. The set-top-box according to claim 9, the processing unit being further arranged to implement at least one first specific processing operation for each first audio channel and at least one second specific processing operation for each second audio channel,
the first specific processing operation(s) and the second specific processing operation(s) being defined depending on the audio rendering capabilities of the at least one audio rendering equipment, of the audio-video rendering equipment or the internal audio rendering device of the set-top box, and/or depending on an audio configuration of the at least one audio rendering equipment.

11. The set-top-box according to claim 9, wherein the set-top-box does not integrate an audio rendering device, and wherein the processing unit is also arranged to transmit the at least one second audio channel to the accessory equipment via the output port and the first wired link for its rendering by the audio-video rendering equipment.

12. The set-top-box according to claim 9, wherein the set-top-box integrates an internal audio rendering device, the processing unit being arranged to transmit the at least one second audio channel to the internal audio rendering device for its rendering by said internal audio rendering device, the processing unit being further arranged to transmit to the accessory equipment, via the output port and the first wired link, at least one second virtual audio channel comprising only zero values.

13. A system comprising:
the accessory equipment according to claim 1; and
a set-top box, comprising:
an output port arranged to be connected to the accessory equipment via a first wired link;
a processing unit arranged to:
acquire a digital audio-video signal comprising a video signal and a multi-channel audio signal;
apply at least one first specific delay to at least one first audio channel and at least one second specific delay to at least one second audio channel of the multi-channel audio signal;
transmit the video signal and the at least one first audio channel to the accessory equipment via the output port and the first wired link, so that the accessory equipment retransmits the video signal to the audio-video rendering equipment via a second wired link and the at least one first audio channel to at least one audio rendering equipment via a wireless link;
transmit the at least one second audio channel to the accessory equipment via the output port and the first wired link for its rendering by the audio-video rendering equipment, or else to an internal audio rendering device integrated in the set-top box for its rendering by said audio rendering device;
the first specific delay(s) and the second specific delay(s) being defined depending on audio rendering capabilities of the at least one audio rendering equipment, of the audio-video rendering equipment or the internal audio rendering device, and/or depending on features of the second wired link and the wireless link.

14. An audio rendering method, implemented in the processing unit of the set-top box according to claim 8, and comprising the steps of:
acquiring a digital audio-video signal comprising a video signal and a multi-channel audio signal;
applying at least one first specific delay to at least one first audio channel and at least one second specific delay to at least one second audio channel of the multi-channel audio signal;
transmitting the video signal and the at least one first audio channel to the accessory equipment via the output port and the first wired link, so that the accessory equipment retransmits the video signal to the audio-video rendering equipment via a second wired link and the at least one first audio channel to at least one audio rendering equipment via a wireless link;
transmitting the at least one second audio channel to the accessory equipment via the output port and the first wired link for its rendering by the audio-video rendering equipment, or else to an internal audio rendering device integrated in the set-top box for its rendering by said audio rendering device;
the first specific delay(s) and the second specific delay(s) being defined depending on audio rendering capabilities of the at least one audio rendering equipment, of the audio-video rendering equipment or the internal audio rendering device, and/or depending on features of the second wired link and the wireless link.

15. (canceled)

16. A non-transitory computer-readable storage medium, on which a computer program is recorded, the computer program comprising program code instructions for the execution of the steps of the audio rendering method according to claim 14 when said program is executed on a computer.
